(19) United States
(12) Patent Application Publication
(10) Pub. No.: US 2003/0108227 A1
(43) Pub. Date: Jun. 12, 2003

(54) Remote control with the fingerprint recognition capability

(75) Inventors: Vasanth Philomin, Briarcliff Manor, NY (US); Miroslav Trajkovic, Ossining, NY (US); Srinivas Gutta, Buchanan, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V., New York, NY

(21) Appl. No.: 10/014,241

(22) Filed: Dec. 11, 2001

(51) Int. Cl. G06K 9/00

(52) U.S. Cl. 382/124

(57) ABSTRACT

Disclosed is a method and system for controlling access to a television set using a remote control unit having a finger verification means. The method includes the steps of: placing at least one finger on the remote control unit for scanning; obtaining fingerprint data indicative of the scanned finger; comparing the fingerprint data to predetermined reference data to establish a fingerprint match; and, if a match is established, providing access to a number of channels associated with the scanned finger. The system includes a fingerprint reader for generating fingerprint data; a processor programmed to prompt the user to enter fingerprint data; and, a fingerprint recognition means for verifying that the user is an authorized user of the remote control apparatus.

### BACKGROUND OF THE INVENTION

1. Field of the Invention

The present invention relates to a personal Identification system, particularly to a method and system for identifying a specific television viewer and setting the television set according to the TV viewer's default setting.

2. Description of the Related Art

There has been an increase in the use of private electronic transaction devices to offer a wide variety of services in the consumer electronic field. Some of these devices use a distinctive biometric characteristic possessed by the user, such as voice, finger print, facial scan, etc., to initiate transactions. The biometric data is mainly used to enhance both the security and convenience of performing many electronic transactions. For example, a camera is proposed to identify subjects through face recognition in the conventional television application to control the TV settings. However, under poor illumination conditions, most vision recognition systems perform poorly, thus unable to identify the subjects. Therefore, the present invention proposes an efficient and accurate system of identifying a particular TV viewer as he or she activates the remote control device to change from one channel to another, so that the television set can positively identify the viewer and tune the television set according to the viewer's default settings.

### SUMMARY OF THE INVENTION

The present invention is directed to a method and system for controlling access to a television set using a remote control unit having a finger verification means.

One embodiment of the present invention is directed to a remote control apparatus for verifying a user's fingerprint identity in order to selectively change the channel displayed on a television set. The apparatus includes a fingerprint reader for generating fingerprint data; a processor programmed to prompt the user to enter fingerprint data; and, a fingerprint recognition means for verifying that the user is an authorized user of the remote control apparatus.

Another embodiment of the present invention is directed to a remote control unit, which includes an input means for prompting the user to place at least one finger on the remote control device for scanning; a processor; and, a finger recognition means controlled by the processor for verifying that the user is authorized to use the remote control unit based upon an indication that that the scanned finger data matches the predetermined fingerprint reference data.

Another embodiment of the present invention is directed to a method of controlling access to a television set using a remote control unit having a finger verification device. The method includes the steps of: placing at least one finger on the remote control unit for scanning; obtaining fingerprint data indicative of the scanned finger; comparing the fingerprint data to predetermined reference data to establish a finger match; and, if a match is established, providing a number of channels associated with the scanned finger.

### DETAILED DESCRIPTION OF THE DRAWINGS

A more complete understanding of the method and apparatus of the present invention may be had by reference to the following detailed description when taken in conjunction with the accompanying drawings wherein:

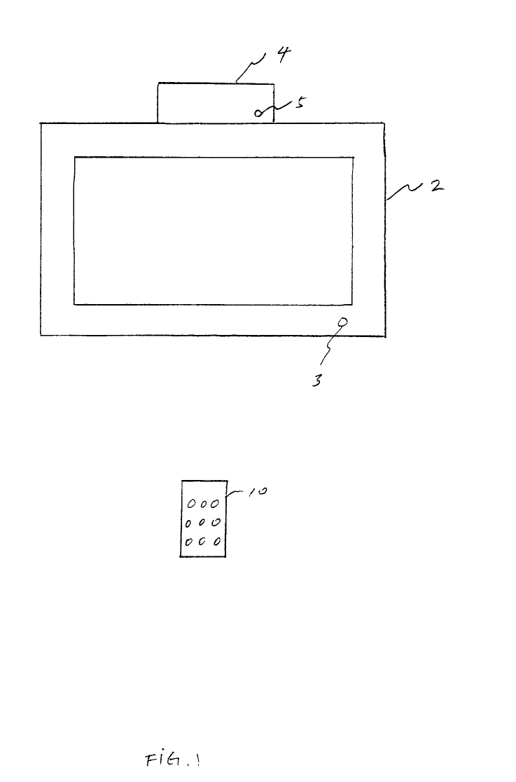

FIG. 1 is a simplified block diagram showing a remote control apparatus communicatively connected to a television set and/or a set-top box according to an embodiment of the present invention;

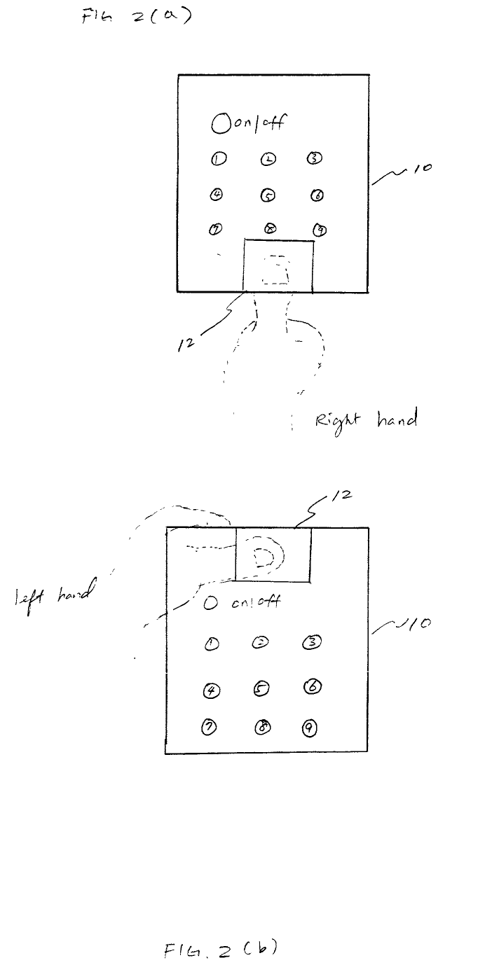

FIGS. 2(a) and 2(b) are diagrams showing a remote control apparatus with the finger verification system according to an embodiment of the present invention;

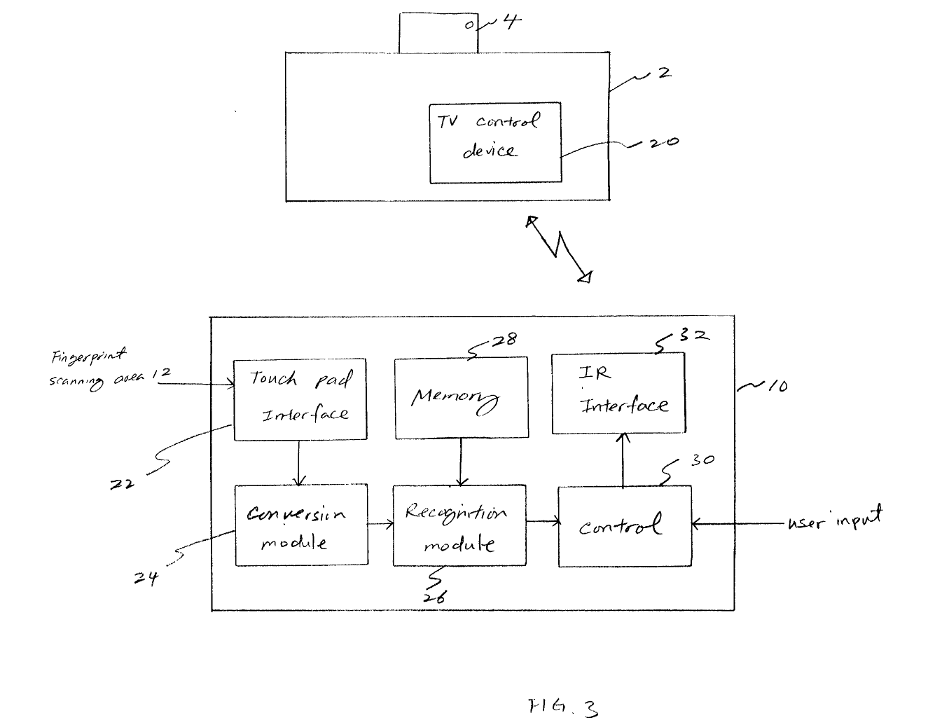

FIG. 3 is a simplified circuit block diagram showing a remote control apparatus and a television set according to an embodiment of the present invention;

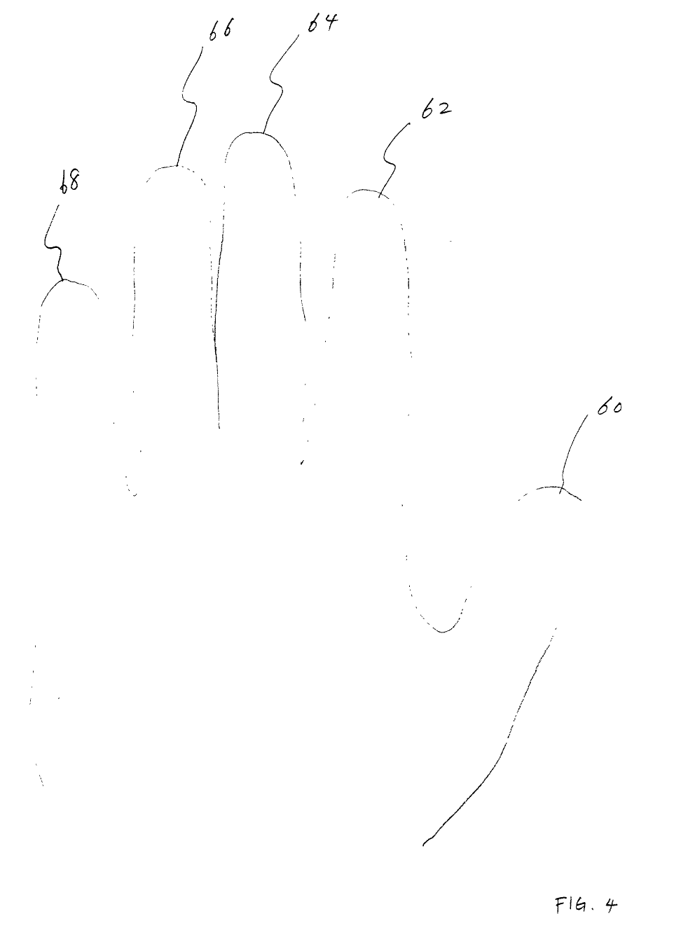

FIG. 4 is a diagram for explaining the assignment of a number of channels to each of the user's fingers in accordance with the present invention;

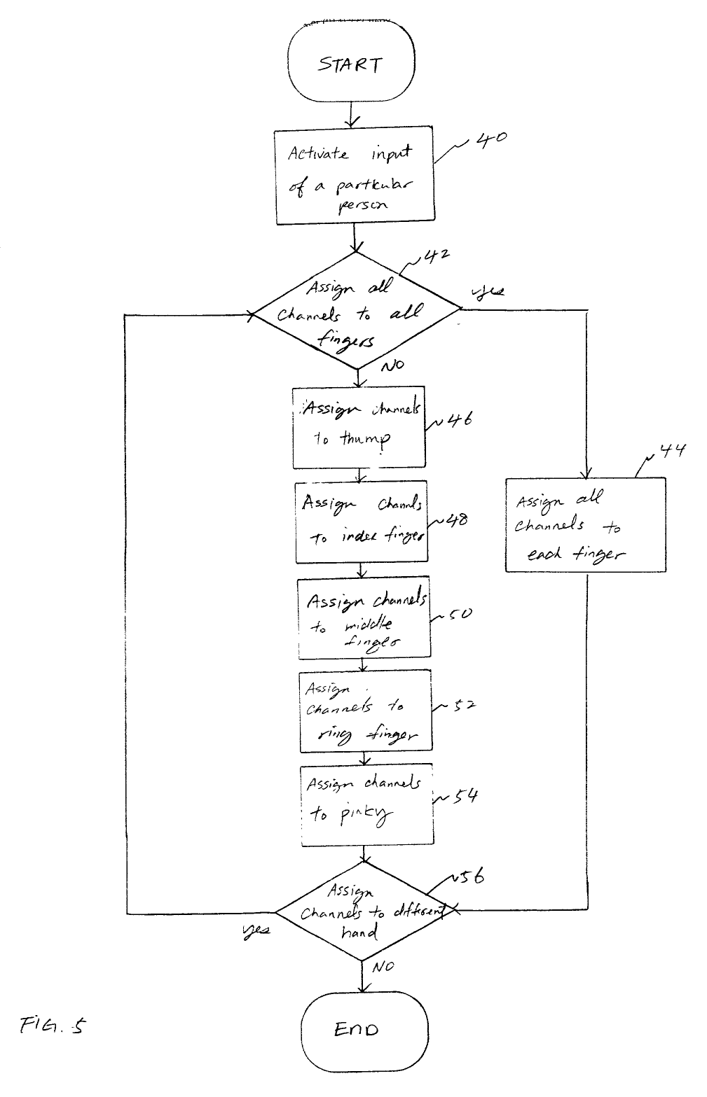

FIG. 5 is a flow chart showing the operation steps involving the assignment of a number of channels to each of the user's fingers in accordance with the present invention; and,

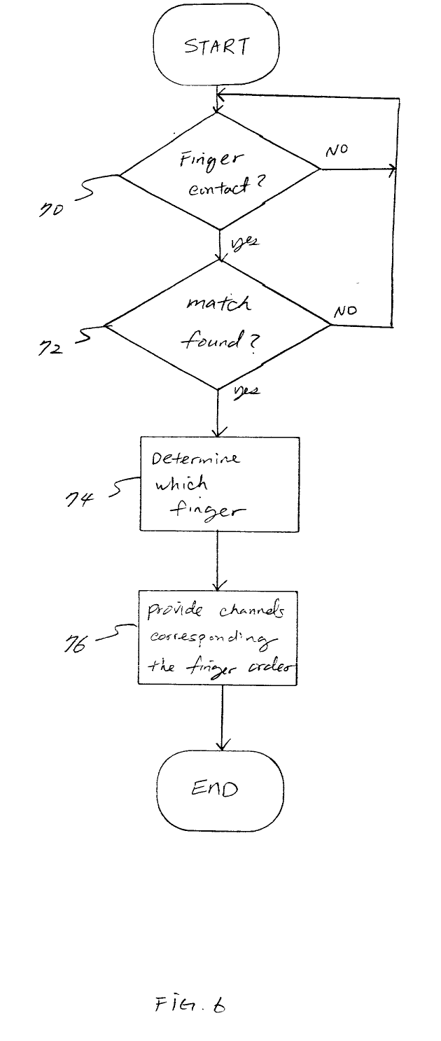

FIG. 6 is a flow chart showing the operation steps of authenticating the remote control user prior to using the remote control apparatus in accordance with the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. For purpose of simplicity and clarity, detailed descriptions of well-known devices, circuits, and methods are omitted so as not to obscure the description of the present invention with unnecessary detail.

FIG. 1 is a simplified block diagram showing a remote control unit 10 and a television set 2 to which the embodiment of the present invention is applicable. The TV set 2 is controlled by the remote control unit 10 via an infrared ray receiver 3. In an alternate embodiment of the present invention, the TV set 10 may be provided with a set-top box 4 with an infrared-ray receiver 5 for controlling the setting of the TV set 2. For communication between the remote control unit 10 and the TV set 2, the transmission medium is not restricted to the infrared ray but it is permissible to use a visible ray, ultraviolet ray, supersonic wave, electronic wave or the like.

According to the principle of the present invention, the remote control unit 10 allows the identification of the TV viewer by comparing the viewer's fingerprint to a previously obtained fingerprint database. To achieve this, a user activates the remote control unit 10 by transmitting a fingerprint signature, via an infrared signal or other remote control signal known in the art, to the TV set 2 or the set-top box 5. Then, upon receiving the fingerprint signature, the TV set 2 or the step-top box 5 authenticates the requesting party's identity by comparing the received fingerprint signature with predetermined fingerprint reference data. It is noted that the database containing the predetermined fingerprint reference data can be also provided in the remote control unit 10 to perform the finger match operation. Upon establishing a match, a number of TV channels associated with the authenticated finger are provided to the user. By granting access to the channels only upon verifying the user, the present invention offers a wide variety of options to the TV viewers. For example, each of the user's fingers can be associated with a different set of channels according to the user's preference for subsequent access by the same user. Or access to a particular channel during a specified time period may be restricted to children or minors if the minor's fingerprint is programmed to be denied from such channel. In the former situation, the inventive feature of assigning favorite channels according to the subject to each of the user's fingers allows the user to save time while surfing the astronomical number of channels that a typical user encounters in this modern time. Currently, over 500 channels are available over a cable broadcast. Hence, this invention can minimize the frustration of browsing unwanted channels and remembering favorite channel numbers to quickly retrieve favorite channels.

FIG. 2 illustrates the remote control unit 10 employing a finger verification operation according to an exemplary embodiment of the present invention. As shown in FIG. 2, the front face of the remote control unit 10 contains an ON/OFF button for activating or terminating the power of the TV set 2 and a plurality of number buttons for selecting a channel. It should be noted that the remote control unit 10 may further include other buttons, for example, “power,” “volume up,” “volume down,” “channel up,” “channel down,” “identification select,” “menu up,” “menu down,” “menu select,” or other features, depending on the particular application. The remote control unit 10 is also provided with a fingerprint scanning area 12 for scanning the fingerprint as the user places his or her finger on the finger scanning area 12. The fingerprints obtained by reflecting or scattering the image of the finger surface onto an image sensor is well known in the art that can be performed in a variety of ways. See for example, U.S. Pat. No. 4,924,085, the content of which is hereby incorporated by reference. Thus, any number of commercially or publicly available image sensor can be utilized in various implementations in accordance with the preferred embodiment of the present invention. Furthermore, although a thumb finger is shown in FIG. 2 for illustrative purposes, it is to be understood that the present invention can support other fingers placed on the top or bottom of the remote control unit 10, either from the left hand or the right hand, or both hands, for fingerprint verification purposes. Therefore, the illustrative drawing shown in FIG. 2 should not impose limitations on the scope of the invention.

With continued reference to FIG. 2, housed within the remote control unit 10 is the finger recognition means, which determines whether the person using the remote control unit 10 is an authorized user of the TV set 2. The detected fingerprints are compared to the user's previously pre-digitized database, created interactively by the users, for a fingerprint match (explained later). To achieve this, the finger recognition means inside the remote control unit 10 captures the detected fingerprint signature and analyzes the user's identification database to establish a fingerprint match with the predetermined fingerprint reference data stored in the database. It should be noted, however, that the database containing the predetermined fingerprint reference data can be also stored in the TV set 2 or the set-top box 4 to perform the fingerprint match operation. Although the exemplary embodiment of the present invention anticipates the use of the fingerprint characteristics of the potential user, any personal profile that is sufficiently unique enough to provide a reasonable probability of a correct identification, and which is capable of being digitally represented and sent via electronic signal, may be utilized in the present invention (i.e., voice print, DNA, palm print or other such unique biometric characteristic).

FIG. 3 is a simplified block diagram showing an electric circuit of the remote control unit 10 and the TV set 2. The remote control unit 10 includes a touch pad interface 22 for scanning the user's fingerprint imaged on the fingerprint scanning area 12; a conversion module 24 for converting the scanned fingerprint information into digital data; a recognition module 26 for verifying the scanned fingerprint pattern registered based on a pre-stored fingerprint data that is stored in the memory 28; and, a controller 30 for receiving the analysis result from the recognition module 26 and transmitting command signals inputted by the user to the TV set via the IR interface 32. Again, the recognition module 26 and the memory 28 can be provided in the TV set 2 or the set-top box 4, coupled to the TV set 2 to perform the fingerprint match operation. In the latter situation, the remote control unit 10 would transmit the scanned fingerprint information, via an infrared signal or other remote control signal known in the art, to the TV set 2 or the set-top box 4. The TV set 2 includes a TV control device 20 for switching or changing the TV setting according to the user's command signals received through the remote control unit 10.

Now, the provision of recognizing fingerprints to identify different TV viewers according to the present invention will be explained in detailed description.

According to the embodiment of the present invention, a particular television viewer may pre-program a number of channels to one or more of his or her fingers using the remote control unit 10 for a subsequent viewing mode of selecting a desired channel. That is, once a group of preferred channels is associated with at least one finger of the user, the user may selectively tune to one of the preferred channels by placing his or her finger to the imaging sensing portion 12 of the remote control unit 10. For example, as shown in FIG. 4, the thumb 60 may be assigned to the user's favorite sports channels, and the index finger 62 may be assigned to a number of news channels that the user frequently watches, etc. Hence, when the user places the thumb 60 on the fingerprint scanning area 12 of the remote control unit 10, the user is provided with the user's favorite sports channels to choose from, thus avoiding the need to browse unwanted channels.

FIG. 5 is a flow chart illustrating the above operation steps of assigning a group of channels of interest to the user utilizing the remote control device 10. FIG. 6 is a flow diagram illustrating the processing performed by the present invention to provide channels of interest to the user. The rectangular elements indicate computer software instructions, whereas the diamond-shaped element represents computer software instructions that affect the execution of the computer software instructions represented by the rectangular blocks. Alternatively, the processing and decision blocks represent steps performed by functionally equivalent circuits such as a digital signal processor circuit or an application specific integrated circuit (ASIC). The flow diagrams illustrate the functional information that one of ordinary skill in the art requires to fabricate circuits or to generate a computer software to perform the processing required of the particular apparatus.

Referring to FIG. 5, if the user wishes to assign a plurality of his or her favorite channels in step 40, the user determines whether to assign all his or her favorite channels commonly to all fingers in step 42. If so, a number of the user's preferred channels is selected and assigned to each of the user's fingers. To this end, the user has to place all of his or her fingers, in sequence, on the fingerprint scanning area 12 of the remote control unit 10, in step 44. Otherwise, the user places one finger at a time on the fingerprint scanning area 12 of the remote control unit to associate a number of preferred group channels to each finger. To achieve this, in step 46, the thumb 60 is placed on the finger image sensing section of the remote control unit 10. Then one or more channels belonging to a particular subject of interest to the user, i.e., sports channels, may be stored in the memory medium 28 of the remote control unit 10, or in the TV set 2/the set-top box 4 for a subsequent retrieval. Similarly, the remaining index 62, middle 64, ring 66, and pinky 68 fingers are associated with a different set of the user's preferred channels in step 48 through step 54. It should be noted that the order of associating different fingers performed in steps 46 through 54 may be changed and that some of the association steps may be skipped as the occasion demands. In addition, it is noted that the present invention can further modify the association of channels to each of the fingers subsequently, by editing the assignment operation steps performed in steps 46 through 54. Finally, in step 56, if the user wishes to assign another group of his or her favorite channels to the other hand, the operation steps 42 to 54 are performed again for the other hand.

Referring to FIG. 6, after generating the reference fingerprint data as discussed above, if a user places one of the fingers on the remote control unit 10 in step 70, the fingerprint is scanned to generate a control signal, representing the digital forms of the scanned fingerprint, and transmitted from the remote control unit 10 to the infrared ray emitting portion 3 of the TV set 2 or to the infrared ray receiving portion 5 of the set-top box 4. In step 72, the scanned digital fingerprint is compared to the pre-recorded reference fingerprint data stored in the TV set 2 or the set-top box 4 to establish a match. It should be noted that the database containing the reference fingerprint data can be also stored in the remote control unit 10 to determine whether the scanned fingerprint matches the prerecorded reference fingerprint data. If the match is established, it is determined which finger matches in step 74. It should be noted that upon establishing a match, the user may be requested to input additional information, such as a personal identification number (PIN) code for further authentication. After determining the identity of the scanned fingerprint, all the channels pre-programmed for that particular fingerprint are provided to the user in step 76. Thus, if the authorized user presses any button on the remote control unit 19, a control signal corresponding to that button is transmitted to the infrared ray emitting portion 3 of the remote control unit 10, or the infrared ray receiving portion 5 of the set-top box 4, so as to perform a corresponding control like the conventional remote control apparatus. Meanwhile, if an unauthorized user touches the remote control unit 10 or if the scanned fingerprint is not within an acceptable discrepancy range of any of the authorized users stored in the user profile database, access to the TV program is denied.

The previous description of the preferred embodiments is provided to enable any person skilled in the art to make or use the present invention. Various modifications to these embodiments, and other embodiments, will be readily apparent to those skilled in the art without the use of the inventive faculty. Thus, the present invention is not intended to be limited to the embodiments shown herein but is to be accorded the widest scope consistent with the principles and novel features disclosed herein.

What is claimed is:

1. A method for controlling access to a television set using a remote control unit having a finger verification device, the method comprising the steps of:
(a) placing at least one finger on said remote control unit for scanning;
(b) obtaining fingerprint data indicative of said scanned finger;
(c) comparing the fingerprint data to predetermined reference data to establish a finger match; and,
(d) if a match is established, providing a number of channels associated with said scanned finger.

2. The method of claim 1, wherein if a match is not established, denying access to said television set.

3. The method of claim 1, further comprising the step of allowing the display of one of the channels associated with said scanned finger upon receiving a request to view said one channel.

4. The method of claim 1, further comprising the steps of transmitting the fingerprint data to said television set and performing said steps (c) and (d).

5. The method of claim 1, wherein the predetermined reference data used in said comparing step is stored in said television set.

6. The method of claim 1, further comprising the steps of transmitting the fingerprint data to a set-top box coupled to said television set and performing said steps (c) and (d).

7. The method of claim 1, wherein the predetermined reference data used in said comparing step is stored in a set-top box coupled to said television set.

8. The method of claim 1, wherein the predetermined reference data used in said comparing step is stored in said remote control unit.

9. A method for controlling the access to a television set using a remote control unit having a finger verification device, the method comprising the steps of:
(a) prompting said user to place at least one finger on said remote control unit for scanning;
(b) recognizing said scanned finger and storing a number of channels associated with the at least one finger to generate finger reference data;
(c) placing at least one finger on the finger verification device of said remote control unit to generate fingerprint data;
(d) comparing the fingerprint data to said finger reference data to establish a fingerprint match; and,
(e) if a match is established, providing the number of said channels associated with said placed finger.

10. The method of claim 9, further comprising the step of providing an indication as to whether or not the finger match is established.

11. The method of claim 9, further comprising the step of repeating said steps (c)-(e) if a match is not established.

12. The method of claim 9, wherein if a match is not established denying access to said television set.

13. The method of claim 9, further comprising the step of allowing the display of one of the channels associated with said placed finger upon receiving a request to view said one channel.

14. The method of claim 9, further comprising the steps of transmitting the fingerprint data to said television set and performing said steps (c) through (e).

15. The method of claim 9, wherein the predetermined reference data used in said comparing step is stored in said television set.

16. The method of claim 9, further comprising the steps of transmitting the fingerprint data to a set-top box coupled to said television set and performing said steps (c) through (e).

17. The method of claim 9, wherein the predetermined reference data used in said comparing step is stored in a set-top box coupled to said television set.

18. The method of claim 9, wherein the predetermined reference data used in said comparing step is stored in said remote control unit.

19. A remote control device for verifying a user's finger identity in order to selectively change the channel displayed on a television set, comprising:
a fingerprint reader for generating fingerprint data;
a processor programmed to prompt said user to enter fingerprint data; and,
a fingerprint recognition means for verifying that said user is an authorized user of said remote control device.

20. The remote control device of claim 19, wherein said fingerprint recognition means is located at said television set.

21. A remote control device for verifying a user's fingerprint identity in order to change selectively the channel displayed on a television set, comprising:
an input means for prompting said user to place at least one finger on said remote control device for scanning;
a processor; and,
a fingerprint recognition means controlled by said processor for verifying that said user is an authorized user of said remote control device based upon an indication that said scanned finger data matches predetermined fingerprint reference data.

22. The remote control device of claim 21, wherein said fingerprint recognition means is located at said television set.
